(19) United States
(12) Patent Application Publication
(10) Pub. No.: US 2016/0217809 A1
(43) Pub. Date: Jul. 28, 2016

(54) SPEECH PROCESSING APPARATUS, SPEECH PROCESSING METHOD, AND COMPUTER PROGRAM PRODUCT

(71) Applicant: KABUSHIKI KAISHA TOSHIBA, Tokyo (JP)

(72) Inventor: Yusuke Kida, Kawasaki (JP)

(73) Assignee: KABUSHIKI KAISHA TOSHIBA, Tokyo (JP)

(21) Appl. No.: 14/925,243

(22) Filed: Oct. 28, 2015

(30) Foreign Application Priority Data
Jan. 22, 2015 (JP) 2015-010666

(51) Int. Cl. G10L 25/90; G10L 21/0208; G10L 25/18

(52) U.S. Cl. CPC G10L 25/90; G10L 25/18; G10L 21/0208

(57) ABSTRACT

According to an embodiment, a speech processing apparatus includes an enhancer, a converter, a filter, and an inverter. The enhancer is configured to generate a frequency spectrum in which a harmonic component included in input sound is enhanced. The converter is configured to convert the frequency spectrum into a first signal in a modulation frequency domain. The filter is configured to filter the first signal to pass human speech. The inverter is configured to convert the filtered first signal into a second signal in a frequency domain.

### CROSS-REFERENCE TO RELATED APPLICATION

This application is based upon and claims the benefit of priority from Japanese Patent Application No. 2015-010666, filed on Jan. 22, 2015; the entire contents of which are incorporated herein by reference.

### FIELD

Embodiments described herein relate generally to a speech processing apparatus, a speech processing method, and a computer program product.

### BACKGROUND

A harmonic structure observed in a vowel part of a speech signal applied with frequency conversion is important information in detecting a speech segment and estimating the fundamental frequency. To find a harmonic structure, various methods for extracting harmonic components, which are frequency components making up the harmonic structure, from a speech signal have been disclosed.

All of such conventionally disclosed harmonic component extraction methods extract a frequency component having power stronger than those of nearby frequency bands as a harmonic component. Such a method therefore will extract noise as a harmonic component when the noise includes a frequency component having power stronger than that of nearby frequency bands, e.g., when a telephone tone or chime sound is mixed in a speech. Such noise may give an adversary effect to the speech detection or the fundamental frequency estimation. Therefore, there has been a demand for creating a mechanism capable of extracting speech harmonic components robustly against such noise.

### BRIEF DESCRIPTION OF THE DRAWINGS

FIG. 1 is a block diagram illustrating an exemplary functional configuration of a speech processing apparatus according to an embodiment;

FIG. 2 is a flowchart illustrating an exemplary process performed by the speech processing apparatus according to the embodiment;

FIG. 3 is a schematic illustrating an exemplary frequency spectrogram;

FIG. 4 is a schematic illustrating an exemplary frequency spectrogram resulting from concatenating a plurality of degree-of-dominance spectrums;

FIG. 5 is a schematic illustrating an extraction of frames 100 to 200 from the frequency spectrogram illustrated in FIG. 4;

FIG. 6 is a schematic illustrating a one-dimensional time signal acquired by extracting a frequency component (A) at each time increment, from the frequency spectrogram illustrated in FIG. 5;

FIG. 7 is a schematic illustrating a one-dimensional time signal acquired by extracting a frequency component (B) at each time increment, from the frequency spectrogram illustrated in FIG. 5;

FIG. 8 is a schematic illustrating a modulation frequency spectrum resulting from applying discrete Fourier transform to the time signal illustrated in FIG. 6;

FIG. 9 is a schematic illustrating a modulation frequency spectrum resulting from applying discrete Fourier transform to the time signal illustrated in FIG. 7;

FIG. 10 is a schematic illustrating an exemplary modulation frequency spectrogram;

FIG. 11 is a schematic illustrating a frequency spectrogram acquired by filtering and performing inverse conversion on modulation frequency spectrogram illustrated in FIG. 10; and

FIG. 12 is a block diagram illustrating an exemplary hardware configuration of the speech processing apparatus.

### DETAILED DESCRIPTION

According to an embodiment, a speech processing apparatus includes an enhancer, a converter, a filter, and an inverter. The enhancer is configured to generate a frequency spectrum in which a harmonic component included in input sound is enhanced. The converter is configured to convert the frequency spectrum into a first signal in a modulation frequency domain. The filter is configured to filter the first signal to pass human speech. The inverter is configured to convert the filtered first signal into a second signal in a frequency domain.

A speech processing apparatus, a speech processing method, and a computer program according to an embodiment will now be explained in detail with reference to the accompanying drawings. The speech processing apparatus according to the embodiment extracts harmonic components of a human speech in input sound, before the speech detection or the fundamental frequency estimation. The input sound is a signal including sound and input to the speech processing apparatus according to the embodiment. In the embodiment, a signal including a speech segment, which is a segment corresponding to a human speech, and a non-speech segment is input to the speech processing apparatus, as the input sound.

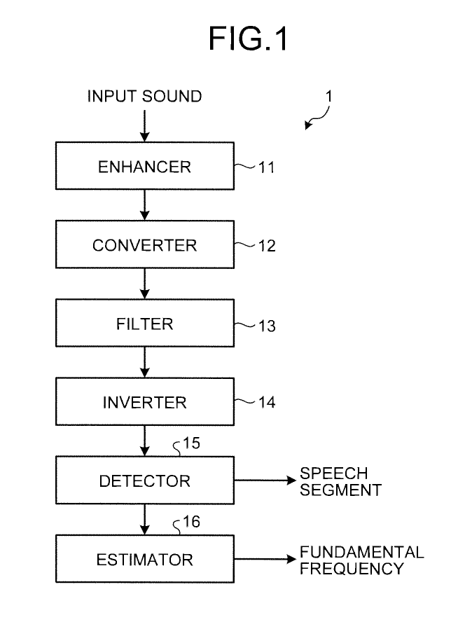

To begin with, a configuration of the speech processing apparatus according to the embodiment will now be explained with reference to FIG. 1. FIG. 1 is a block diagram illustrating an exemplary functional configuration of the speech processing apparatus 1 according to the embodiment. As illustrated in FIG. 1, the speech processing apparatus 1 includes an enhancer 11, a converter 12, a filter 13, an inverter 14, a detector 15, and an estimator 16.

The enhancer 11 generates a frequency spectrum in which the harmonic components of the input sound are enhanced, at each time increment, and generates a frequency spectrogram in which the time and the frequency are represented along the respective axes, by concatenating the frequency spectrums generated at the respective time increments. The enhancer 11 may be configured to generate a frequency spectrum from the input sound and to pass the frequency spectrums to the converter 12 at each time increment, so that the converter 12 is caused to generate a frequency spectrogram by concatenating the frequency spectrums generated by the enhancer 11 corresponding to the respective time increments.

The enhancer 11 may be configured to generate a degree-of-dominance spectrum disclosed in Japanese Patent Application Laid-open No. 2003-173195, for example, as a frequency spectrum having the harmonic components enhanced. The degree-of-dominance spectrum disclosed in Japanese Patent Application Laid-open No. 2003-173195 is generated through: an instantaneous frequency extracting process that extracts instantaneous frequencies corresponding to respective frequency bands from an input signal, at each time increment; a signal power extracting process that extracts an input signal power of the center frequency of each of the frequency bands; a frequency difference extracting process that extracts the difference between the center frequency and the instantaneous frequency of each of the bands that are adjacent to the center frequency; and a degree-of-dominance calculating process that calculates the sum of the frequency differences, for each of the center frequencies, and acquires a degree-of-dominance. Instead of extracting the difference between the center frequency and the instantaneous frequency of each of the bands adjacent to the center frequency, the frequency difference extracting process may extract the difference between an instantaneous frequency corresponding to the center frequency and the instantaneous frequency of each of the bands adjacent to the center frequency.

The enhancer 11 may be configured to generate a frequency spectrum other than the degree-of-dominance spectrum disclosed in Japanese Patent Application Laid-open No. 2003-173195, as the frequency spectrum having the harmonic components enhanced. For example, the enhancer 11 may generate an LPC residual spectrum disclosed in Kenichi Noguchi, et al., “Single-channel non-stationary noise reduction in a teleconference”, IEICE Technical Report, Engineering Acoustics (EA) 105(403), pp. 31-36 (2005), as the frequency spectrum having the harmonic components enhanced, for example. The enhancer 11 may also generate a frequency spectrum acquired by suppressing (liftering) the low-order components by applying cepstral analysis to the input sound, and applying inverse discrete cosine transform to the result, as a frequency spectrum having the harmonic components enhanced, for example. The enhancer 11 may also generate an instantaneous frequency spectrum disclosed in Cited Literature 1 below, as the frequency spectrum having the harmonic components enhanced, as another example.

Cited Literature 1: Toshihiko Abe, et al., “Pitch Estimation Based on Instantaneous Frequency in Noisy Environments”, The Transactions of the Institute of Electronics, Information and Communication Engineers, D-II INFORMATION-SYSTEM, II-INFORMATION PROCESSING J79-D-2(11), pp. 1771-1781 (1996)

The converter 12 converts the frequency spectrogram generated by the enhancer 11 into signals in a modulation frequency domain. By extracting a component of a specific frequency bin from the frequency spectrogram, which is generated by the enhancer 11, at each time increment, a one-dimensional time signal is acquired. By frequency-converting the time signal, a frequency spectrum in the modulation frequency domain is acquired. This acquired frequency spectrum is referred to as a modulation frequency spectrum. The frequency-direction axis in the modulation frequency spectrum represents the modulation frequency. The converter 12 can convert the frequency spectrogram generated by the enhancer 11 into a modulation frequency spectrogram in which the modulation frequency and the frequency are represented along the respective axes, by performing the process described above to each of the frequency bins in the frequency spectrogram.

The filter 13 filters the modulation frequency spectrogram to pass human speech. It is known that information that is important for intelligibility of human speech is distributed around 1 hertz to 16 hertz along the modulation frequency axis (for example, see Cited Literature 2 below). Using this characteristic, the filter 13 may filter the modulation frequency spectrogram using a filter that passes the components around 1 hertz to 16 hertz in the modulation frequency axis, and removing any components other than such components, for example.

Cited Literature 2: N. Kanedera, et al., “On the properties of modulation spectrum for continuous speech recognition”, Proceedings of Acoustical Society of Japan, 1999(1), pp.3-4 (1999).

The inverter 14 performs a frequency inverse conversion for converting the modulation frequency spectrogram filtered by the filter 13 into a frequency spectrogram in the original frequency domain (the same frequency domain as that of the frequency spectrogram before the spectrogram is converted by the converter 12). By extracting a component of a specific frequency bin from the modulation frequency spectrogram filtered by the filter 13, a signal in a one-dimensional modulation frequency domain is acquired. By performing the frequency inverse conversion on the signal, a time signal corresponding to the specific frequency bin is acquired. The inverter 14 can convert the modulation frequency spectrogram filtered by the filter 13 into a frequency spectrogram in the original frequency domain, by performing the process described above to each of the frequency bins in the modulation frequency spectrogram.

The frequency spectrogram acquired through the process performed by the inverter 14 represents signals in which harmonic components of human speech included in the input sound are enhanced. In other words, the speech processing apparatus 1 according to the embodiment is capable of extracting harmonic components of human speech included in input sound appropriately, by causing the enhancer 11 through the inverter 14 to apply their respective processes to the input sound.

The detector 16 detects a speech segment from the input sound based on the frequency spectrogram generated by the inverter 14. A speech segment may be detected using, for example, a method for breaking up the frequency spectrogram into a plurality of frequency spectrums, and by obtaining an average power of each frequency bin in each of the frequency spectrums that correspond to the respective time increments, but without any limitation. In such a case, the detector 15 detects a segment having an average power exceeding a threshold as a speech segment, among the segments of the input sound, for example. The detector 16 may also detect a speech segment using a method of passing each of the frequency spectrums into various comb filters each of which has a different comb interval, and detecting a speech segment using the maximum response. In such a case, the detector 16 detects a segment from which the maximum response is acquired as a speech segment, among the segments of the input signal, for example. It is also possible to estimate the fundamental frequency from the comb interval of the comb filter that outputs the maximum response.

The estimator 17 estimates the fundamental frequency of a human speech included in the input sound, based on the frequency spectrogram generated by the inverter 14. The estimation of the fundamental frequency performed by the estimator 17 may be performed to the speech segments detected by the detector 16, or may be performed in parallel with the speech detection performed by the detector 16. As the fundamental frequency estimation method, the estimator 17 may use the method for estimating the fundamental frequency using the degree-of-dominance in the harmonic structure, as disclosed in Japanese Patent Application Laid-open No. 2003-173195, for example, but without any limitation.

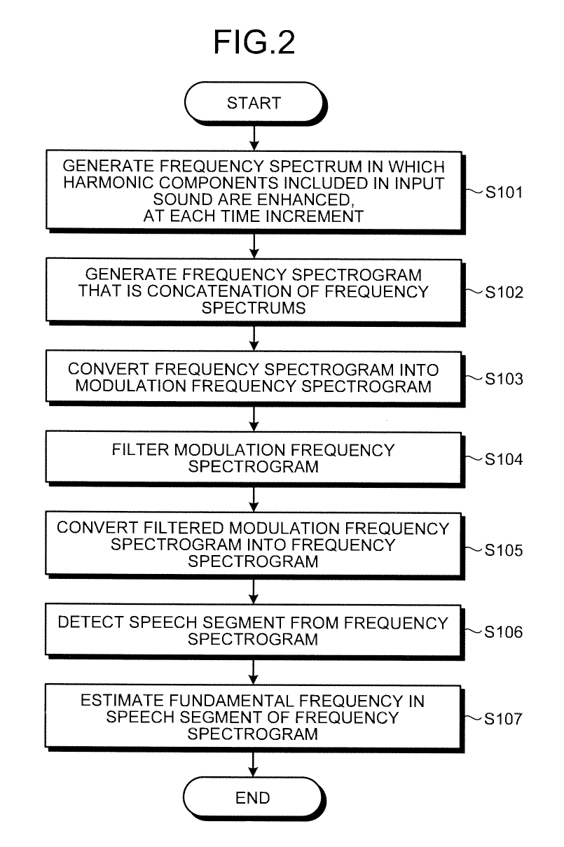

An operation performed by the speech processing apparatus 1 according to the embodiment will now be explained with reference to FIG. 2. FIG. 2 is a flowchart illustrating an exemplary process performed by the speech processing apparatus 1. A series of steps illustrated in the flowchart in FIG. 2 is repeated every time a piece of input sound is input to the speech processing apparatus 1.

To begin with, when the process illustrated in the flowchart of FIG. 2 is started, the enhancer 11 generates a frequency spectrum in which the harmonic components of the input sound are enhanced, at each time increment (Step S101). The enhancer 11 then generates a frequency spectrogram having the time and the frequency represented by the respective axes, by concatenating the frequency spectrums generated at the respective time increments (Step S102). The frequency spectrogram generated by the enhancer 11 is supplied to the converter 12.

The converter 12 then converts the frequency spectrogram supplied by the enhancer 11 into a modulation frequency spectrogram having the modulation frequency and the frequency represented by the respective axes (Step S103). The modulation frequency spectrogram acquired by causing the converter 12 to convert the frequency spectrogram is supplied to the filter 13.

The filter 13 then filters the modulation frequency spectrogram supplied from the converter 12 to pass human speech (Step S104). The modulation frequency spectrogram filtered by the filter 13 (having passed the filter) is supplied to the inverter 14.

The inverter 14 then converts the modulation frequency spectrogram supplied from the filter 13 (filtered modulation frequency spectrogram) into a frequency spectrogram having the time and the frequency represented by the respective axes (Step S105). The frequency spectrogram acquired by causing the inverter 14 to convert the modulation frequency spectrogram is supplied to the detector 15.

The detector 15 then detects a speech segment from the input sound, based on the frequency spectrogram supplied from the inverter 14 (Step S106). The information of speech segments detected by the detector 15 is supplied to the estimator 16, and is also output to an output apparatus such as a display or a speaker, a file storage device such as a hard disk drive (HDD), or a communication interface (I/F) connected to a network, for example.

The estimator 16 then estimates the fundamental frequency of a speech segment detected from the input sound by the detector 15, based on the frequency spectrogram supplied from the inverter 14 (Step S107). The information of the fundamental frequency estimated by the estimator 17 is output to an output apparatus such as a display or a speaker, a file storage device such as an HDD, or a communication interface I/F connected to a network, for example.

An exemplary process performed by the speech processing apparatus 1 according to the embodiment will now be explained more in detail using some specific examples. In these examples, it is assumed that the degree-of-dominance spectrum disclosed in Japanese Patent Application Laid-open No. 2003-173195 is generated by the enhancer 11 as the frequency spectrum (the frequency spectrum in which the harmonic components of the input sound are enhanced).

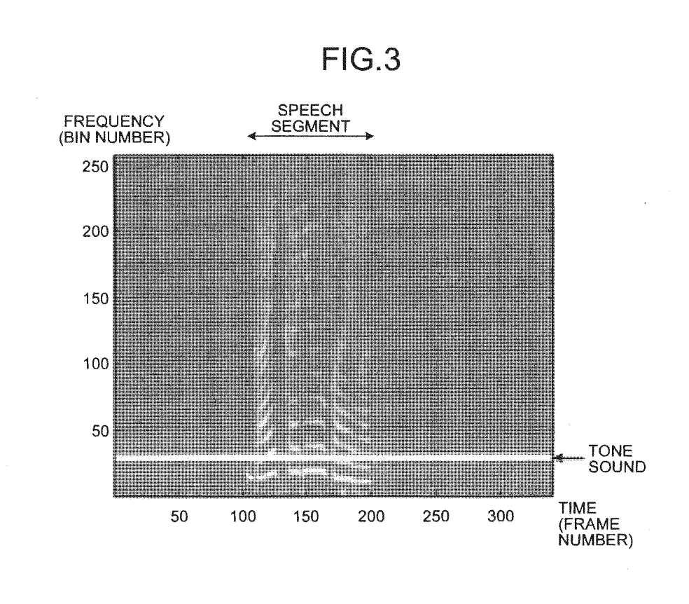

FIG. 3 is a schematic illustrating an exemplary frequency spectrogram resulting from breaking up the input sound into a plurality of frames, and frequency-converting the signals of the respective frames. In FIG. 3, the horizontal axis represents the frame number, and the vertical axis represents the frequency bin number. It can be observed that, from this frequency spectrogram illustrated in FIG. 3, a speech is found around the frames 100 to 200 of the input sound. This segment is a speech segment. In this speech segment, the structure including strong-power components arranged at an equal interval along the frequency axis represents the harmonic structure observed in a vowel part. In the exemplary frequency spectrogram illustrated in FIG. 3, a tone sound having strong power is steadily observed around the 30th frequency bin, in addition to the harmonic components.

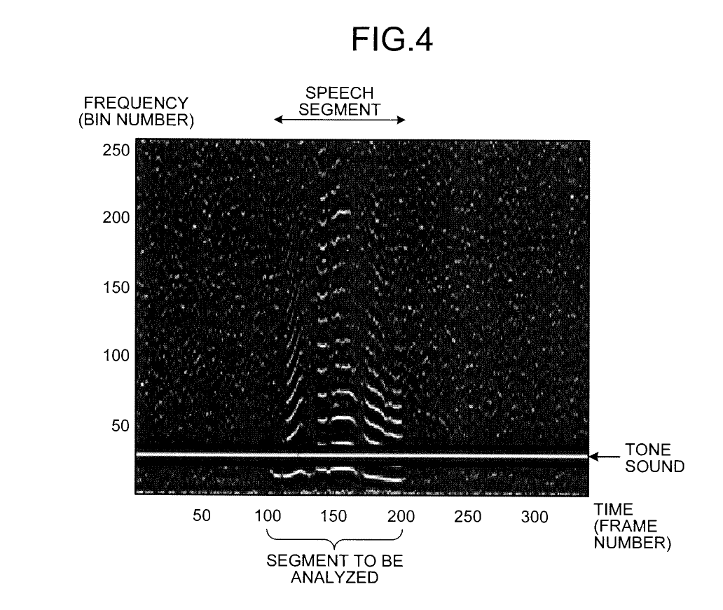

FIG. 4 is a schematic illustrating an exemplary frequency spectrogram acquired by extracting a degree-of-dominance spectrum in units of one frame from the same input sound as that used in FIG. 3, using the method disclosed in Japanese Patent Application Laid-open No. 2003-173195, and by concatenating the degree-of-dominance spectrums. Comparing the frequency spectrogram illustrated in FIG. 4 with the frequency spectrogram illustrated in FIG. 3, it can be observed that, because FIG. 4 represents the extraction of the degree-of-dominance spectrums, the harmonic components of the input sounds are enhanced, with nearby background noise suppressed. The tone sound, however, is not suppressed, but rather is enhanced, in the same manner as the harmonic components of the speech. This is because, with the method of extracting the degree-of-dominance spectrums, a signal component with a power stronger than that of nearby frequency bands is considered as a harmonic component, and enhanced. The speech detection and the fundamental frequency estimation cannot be performed correctly, if such a degree-of-dominance spectrum with noise mixed in a speech is used as it is.

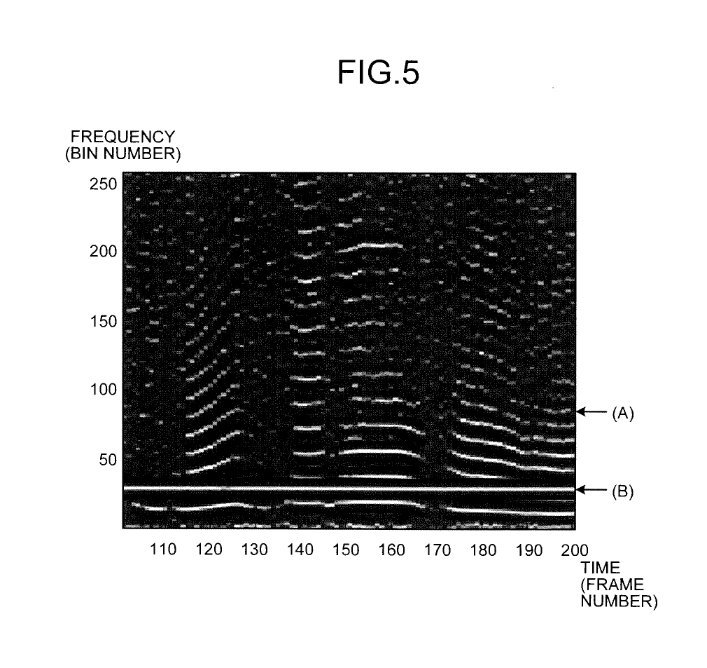

FIG. 5 is a schematic illustrating an extraction of the frames 100 to 200 from the frequency spectrogram illustrated in FIG. 4. Hereinafter, in this example, this segment is assumed to be the segment to be analyzed, in explaining the specific operations performed at Step S103 to Step 5105 in the flowchart of FIG. 2.

At Step S103, the converter 12 converts the frequency spectrogram into a modulation frequency spectrogram. Explained now in this example are exemplary two frequencies (A) and (B) illustrated in FIG. 5. The frequency (A) represents the 80th frequency bin, and the frequency (B) represents the 30th frequency bin.

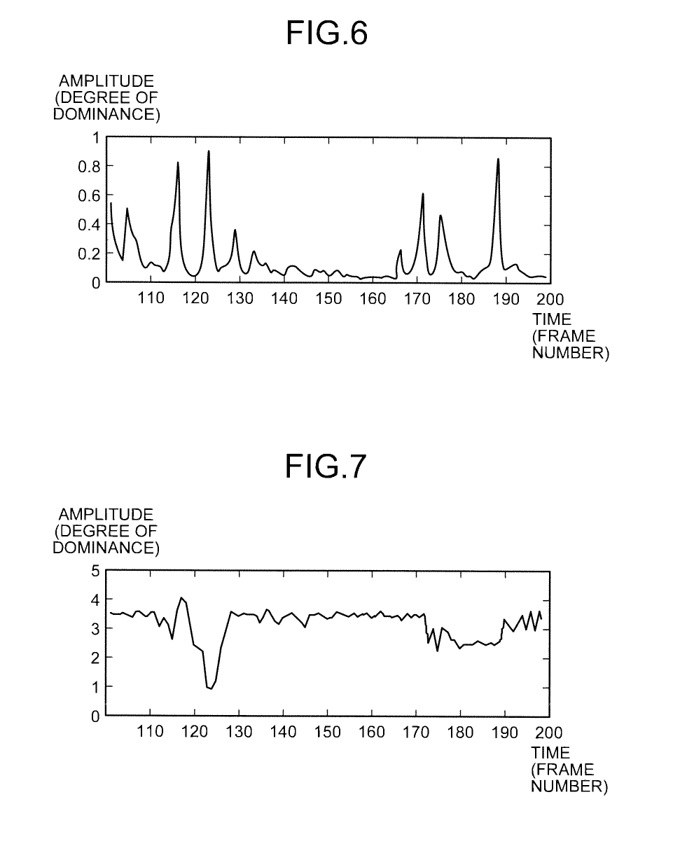

FIG. 6 is a schematic illustrating a one-dimensional time signal acquired by extracting the frequency component (A) at each time increment, from the frequency spectrogram illustrated in FIG. 5. It can be seen that, from the time signal illustrated in FIG. 6, the signal at the frequency (A) has amplitude (degree of dominance) that fluctuates greatly. This is because different amplitude is observed at the time increment at which a harmonic component overlaps with the frequency (A), and at the time increment at which the harmonic component does not overlap with the frequency (A), as a result of a change in the position of the harmonic component in the harmonic structure along the frequency axis, such a change caused by a change in the pitch of the speech.

FIG. 7 is a schematic illustrating a one-dimensional time signal acquired by extracting the frequency component (B) at each time increment, from the frequency spectrogram illustrated in FIG. 5. Comparing the time signal illustrated in FIG. 7 with the time signal illustrated in FIG. 6, it can be seen that the signal in FIG. 7 has higher amplitude than that in FIG. 6, and varies less than the signal in FIG. 6. This is because the amplitude of the tone sound is dominant at the frequency (B), and the amplitude of the tone sound fluctuates less.

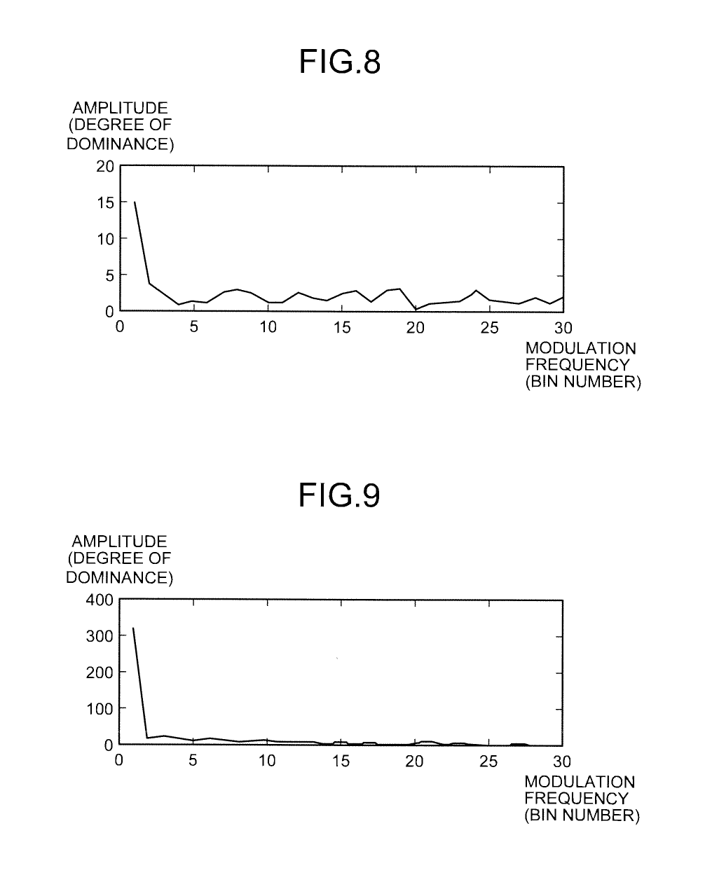

FIG. 8 is a schematic illustrating a modulation frequency spectrum resulting from applying discrete Fourier transform to the time signal illustrated in FIG. 6. FIG. 9 is a schematic illustrating a modulation frequency spectrum resulting from applying discrete Fourier transform to the time signal illustrated in FIG. 7. In FIG. 8, an offset component (the component at the modulation frequency of 0 hertz) has amplitude of about 15, and the other modulation frequencies have amplitude of five or so at most. By contrast, in FIG. 9, the offset component has amplitude of about 300, which is much higher than those of the other modulation frequencies. This is because the tone sound component, having high amplitude but fluctuating less, is converted into the offset component in the frequency domain.

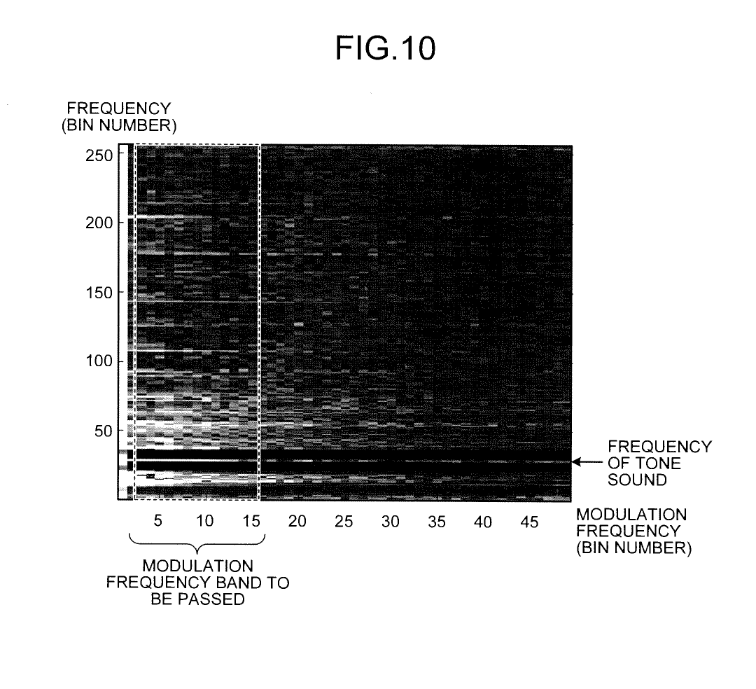

FIG. 10 is a schematic illustrating an exemplary modulation frequency spectrogram acquired by applying the process described above to all of the frequency bins. In the modulation frequency spectrogram illustrated in FIG. 10, while components other than the offset component are not observed very much near the 30th frequency bin that includes the tone sound, other frequency bins that includes speech have many components other than the offset.

At Step S104, the filter 13 then filters the modulation frequency spectrogram to pass human speech. Used in this example is a filter for passing the components in the modulation frequency bins with numbers 2 to 16 (the section surrounded by a dotted line in FIG. 10), and cutting down the other components to zero from the modulation frequency spectrogram illustrated in FIG. 10. With this process, the tone sound, which is an offset component in the modulation frequency domain, is filtered out.

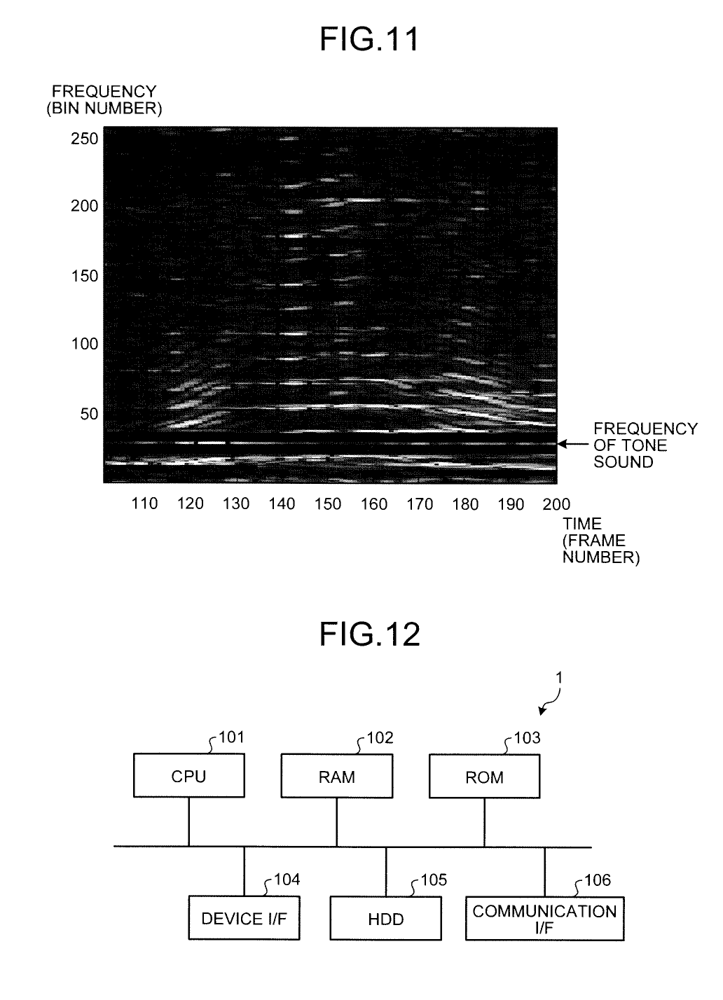

At Step S105, the inverter 14 then converts the modulation frequency spectrogram resulting from filtering the frequency spectrogram into a frequency spectrogram. FIG. 11 is a schematic illustrating a frequency spectrogram resulting from filtering and performing the frequency inverse conversion on the modulation frequency spectrogram illustrated in FIG. 10. Comparing the frequency spectrogram illustrated in FIG. 11 with the frequency spectrogram illustrated in FIG. 5, it can be seen that the tone sound observed in the frequency spectrogram illustrated in FIG. 5 is hardly observed in the frequency spectrogram illustrated in FIG. 11.

Based on the above, it should be clear that the harmonic components of a speech can be extracted robustly against noise such as tone sound, in a manner less influenced by such noise, by using a frequency spectrogram acquired by filtering the modulation frequency spectrogram with a filter designed to pass human speech, and performing the frequency inverse conversion on the filtered modulation frequency spectrogram. As a result, by performing a speech detection or fundamental frequency estimation using such a frequency spectrogram, these processes can be performed highly accurately.

As explained above in detail using some specific examples, the speech processing apparatus 1 according to the embodiment generates a frequency spectrum in which the harmonic components of the input sound are enhanced (a frequency spectrogram), and converts the frequency spectrum into signals in the modulation frequency domain (into a modulation frequency spectrogram). The speech processing apparatus 1 then generates signals in which harmonic components of human speech included in the input sound are enhanced by filtering the signals in the modulation frequency domain with a filter designed to pass human speech, and converting the filtered modulation frequency domain signals into signals in the frequency domain (a frequency spectrogram). Therefore, with the speech processing apparatus 1 according to the embodiment, the harmonic component of a speech can be extracted robustly against noise, even when the speech is mixed with noise including a strong-power frequency component, being stronger than that of nearby frequency bands, such as a telephone tone or chime sound.

Furthermore, the speech processing apparatus 1 according to the embodiment can detect a speech segment from the input sound accurately, by detecting a speech segment based on the converted signals. Furthermore, the speech processing apparatus 1 according to the embodiment can estimate the fundamental frequency of a speech included in the input sound accurately, by estimating the fundamental frequency based on the converted signals.

Furthermore, the speech processing apparatus 1 according to the embodiment performs processes using a frequency spectrum in which the harmonic components of the input sound are enhanced, e.g., a degree-of-dominance spectrum, instead of a frequency spectrum that is merely a frequency-conversion of the input sound. Therefore, any enveloping component included in the spectrum of speech frequencies, for example, can be removed in advance, so that the harmonic components can be extracted efficiently.

By using a general-purpose computer system as basic hardware, and executing a predetermined computer program (software) on the computer system, for example, the speech processing apparatus 1 according to the embodiment can implement the units described above (the enhancer 11, the converter 12, the filter 13, the inverter 14, the detector 15, and the estimator 16).

FIG. 12 is a block diagram illustrating an exemplary hardware configuration of the speech processing apparatus 1 according to the embodiment. As illustrated in FIG. 12, the speech processing apparatus 1 has a hardware configuration of a general computer including a processor such as a central processing unit (CPU) 101, a storage device such as a random access memory (RAM) 102 and a read-only memory (ROM) 103, a device I/F 104 for connecting a peripheral device, a file storage device such as an HDD 105, and a communication interface I/F 106 for communicating with the external over a network.

The computer program is provided recorded in a recording medium, which may be provided as a computer program product, such as a magnetic disk (e.g., a flexible disk or a hard disk), an optical disc (e.g., a compact disc read-only memory (CD-ROM), a compact disc recordable (CD-R), a compact disc rewritable (CD-RW), a digital versatile disc read-only memory (DVD-ROM), a digital versatile disc recordable (DVD±R), a digital versatile disc rewritable (DVD±RW), or a Blu-ray (registered trademark) disc), or a semiconductor memory. The recording medium for recording the computer program may store the computer program in any way as long as a computer system can read such a recording medium. The computer program may be configured to be installed on a computer system in advance, or to be distributed over a network and installed as required.

The computer program executed on the computer system has a modular structure including the units that are functional units of the speech processing apparatus 1 according to the embodiment (the enhancer 11, the converter 12, the filter 13, the inverter 14, the detector 15, and the estimator 16). By causing a processor to read the computer program and to execute the computer program as required, these units are generated on a main memory such as the RAM 102.

The units included in the speech processing apparatus 1 according to the embodiment (the enhancer 11, the converter 12, the filter 13, the inverter 14, the detector 15, and the estimator 16) may be partly or entirely implemented as specialized hardware such as an application specific integrated circuit (ASIC) or a field-programmable gate array (FPGA), in addition to the implementation as a computer program (software).

Furthermore, the speech processing apparatus 1 according to the embodiment may be configured as a network system in which a plurality of computers are interconnected communicatively and in which the units described above are distributed among the computers.

One embodiment of the present invention is described above. The embodiment described herein is, however, presented as merely an example, and is not intended to limit the scope of the present invention in any way. The novel embodiment described herein may be embodied in any other various ways, and various omissions, replacements, and modifications are still possible without deviating from the essence of the present invention. The embodiment described herein and modifications thereof are included in the scope and the essence of the present invention, and falls within the scope of the present invention defined by the appended claims and their legal equivalent.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech processing apparatus comprising:
an enhancer configured to generate a frequency spectrum in which a harmonic component included in input sound is enhanced;
a converter configured to convert the frequency spectrum into a first signal in a modulation frequency domain;
a filter configured to filter the first signal to pass human speech; and
an inverter configured to convert the filtered first signal into a second signal in a frequency domain.

2. The apparatus according to claim 1, further comprising a detector configured to detect a speech segment that is a segment of a human speech included in the input sound, based on the second signal.

3. The apparatus according to claim 1, further comprising an estimator configured to estimate a fundamental frequency of a human speech included in the input sound, based on the second signal.

4. The speech processing apparatus according to claim 1, wherein the enhancer is configured to generate a degree-of-dominance spectrum as the frequency spectrum.

5. A speech processing method executed by a speech processing apparatus, the method comprising:
generating a frequency spectrum in which a harmonic component included in input sound is enhanced;
converting the frequency spectrum into a first signal in a modulation frequency domain;
filtering the first signal to pass human speech; and
converting the filtered first signal into a second signal in a frequency domain.

6. A computer program product comprising a computer-readable medium containing a program executed by a computer, the program causing the computer to execute:
generating a frequency spectrum in which a harmonic component included in input sound is enhanced;
converting the frequency spectrum into a first signal in a modulation frequency domain;
filtering the first signal to pass human speech; and
converting the filtered first signal into a second signal in a frequency domain.
